(19) United States
(12) Patent Application Publication
(10) Pub. No.: US 2016/0334545 A1
(43) Pub. Date: Nov. 17, 2016

(54) SYSTEM AND METHOD FOR WEATHER DATA PROCESSING IN A MOBILE NETWORK

(71) Applicant: Weendy, Inc., San Francisco, CA (US)

(72) Inventors: Ioannis Varelas, Oakland, CA (US); Aikaterini Stroponiati, Oakland, CA (US)

(73) Assignee: Weendy, Inc., San Francisco, CA (US)

(21) Appl. No.: 14/710,514

(22) Filed: May 12, 2015

(51) Int. Cl. G01W 1/00; H04W 4/02

(52) U.S. Cl. CPC G01W 1/00; H04W 4/02

(57) ABSTRACT

Systems are provided which enable a method which includes determining the location of a particular mobile device and collecting location data corresponding to a plurality of mobile devices within the particular geographic area, the geographic area defined based on the location of the particular mobile device. Weather data corresponding to the plurality of mobile devices is collected based on sensor measurements from the plurality of mobile devices. A weather condition is determined based on the location data and the weather data corresponding to the plurality of mobile devices, and the weather condition is reported to a user of the particular mobile device. Other methods are provided in which one or more user-provided indications of comfort corresponding to one or more determined weather conditions are used in determining a level of comfort corresponding to a particular weather condition for the user.

### BACKGROUND

Conventional weather forecasting relies on a variety of different data collection apparatus including satellites, weather balloons, and ground weather stations. The more data collected from more data collection apparatus, the more accurate a forecast can be made based on existing models.

Modern mobile communication devices such as smart phones include an increasing variety of sensors which provide data for applications. Mobile devices enable collection of location data, for example via Global Positioning System (“GPS”) hardware or cell tower triangulation, such that accurate location of a device can be derived. Accelerometers detect acceleration including change in direction, change in velocity, impact, and vibration. Gyroscope sensors sense changes in orientation (rotation). Barometers sense atmospheric pressure useful to estimate altitude for improving GPS accuracy. Proximity sensors incorporate infrared LEDs and infrared light sensors to enable determining if a user's head is near the device to permit the inference that a user is in a phone call. Ambient light levels detected by a light sensor on a mobile device permit automatic adjustment of screen brightness. A magnetometer on a mobile device can detect magnetic fields for example to enable a compass application. A thermometer can be provided on a mobile device to measure ambient temperature. A mobile device can include a humidity sensor to measure ambient humidity.

It has been recognized in the art that the various sensors on a mobile device allow for the collection of data useful for determining weather conditions. However, there are a number of technical challenges hindering effective use of mobile device sensor data from mobile devices operated by a plurality of different users. Moreover, weather information itself is often confusing and uninformative to the consumer of such information. Terms such as humidity and barometric pressure for example may not be properly understood by a consumer of weather information.

### SUMMARY

This Summary introduces simplified concepts that are further described below in the Detailed Description of Illustrative Embodiments. This Summary is not intended to identify key features or essential features of the claimed subject matter and is not intended to be used to limit the scope of the claimed subject matter.

A method is provided which includes determining the location of a particular mobile device and collecting location data corresponding to a plurality of mobile devices within the particular geographic area, the geographic area defined based on the location of the particular mobile device. Weather data corresponding to the plurality of mobile devices is collected based on sensor measurements from the plurality of mobile devices. A weather condition is determined based on the location data and the weather data corresponding to the plurality of mobile devices, and the weather condition is reported to a user of the particular mobile device.

Another method is provided in which a first location of a particular mobile device is determined, and location data is collected corresponding to a first plurality of mobile devices within a particular geographic area defined based on the first location of the particular mobile device. Weather data is collected corresponding to the first plurality of mobile devices based on sensor measurements from the first plurality of mobile devices, and a first weather condition is determined based on the location data and the weather data corresponding to the first plurality of mobile devices. An indication of comfort corresponding to the first weather condition is received from a user of the particular mobile device, and the indication of comfort is associated to the first weather condition. A second location of a particular mobile device is determined, and location data is collected corresponding to a second plurality of mobile devices within a particular geographic area defined based on the second location of the particular mobile device. Weather data is collected corresponding to the second plurality of mobile devices based on sensor measurements from the second plurality of mobile devices, and a second weather condition is determined based on the location data and the weather data corresponding to the second plurality of mobile devices. A level of comfort is determined corresponding to the second weather condition based on the indication of comfort received from the user and the determined second weather condition, and the determined level of comfort is reported to the user.

Another method is provided in which location data corresponding to a first plurality of mobile devices is collected. Weather data corresponding to the first plurality of mobile devices based on sensor measurements from the first plurality of mobile devices is collected. A plurality of weather conditions are determined corresponding to particular times and particular locations based on the location data and the weather data corresponding to the first plurality of mobile devices. A plurality of indications of comfort respectively corresponding to the determined plurality of weather conditions are received from a user of a particular mobile device. The plurality of indications of comfort are associated respectively to the plurality of weather conditions. A location of the particular mobile device is determined. Location data corresponding to a second plurality of mobile devices is collected. Weather data is collected corresponding to the second plurality of mobile devices based on sensor measurements from the second plurality of mobile devices. A particular weather condition is determined based on the location data and the weather data corresponding to the second plurality of mobile devices. A level of comfort is determined corresponding to the determined particular weather condition based on the particular weather condition and based on the indications of comfort received from the user and the respectively associated plurality of weather conditions, and the determined level of comfort is reported to the user.

### BRIEF DESCRIPTION OF THE DRAWING(S)

A more detailed understanding may be had from the following description, given by way of example with the accompanying drawings. The Figures in the drawings and the detailed description are examples. The Figures and the detailed description are not to be considered limiting and other examples are possible. Like reference numerals in the Figures indicate like elements wherein:

FIG. 1 is a diagram of a system for collecting and processing weather data from a plurality of mobile devices;

FIG. 2 is a flowchart showing a method for determining and reporting a weather condition;

FIG. 3 is a schematic showing data flow in a process for determining a weather condition;

FIG. 4 is a schematic showing data flow in a process for determining a user comfort model based on weather conditions and user-provided comfort indications;

FIG. 5 is a schematic showing data flow in a process for determining a user's level of comfort based on a weather condition;

FIG. 6 is a map showing mobile devices positioned in a particular geographic area configured for taking weather data sensor measurements;

FIGS. 7-11 show a mobile device with a user interface displaying outputs enabled by an application operating in accord with described processes; and

FIGS. 12-13 are flowcharts showing other methods for determining and reporting a weather condition.

### DETAILED DESCRIPTION OF ILLUSTRATIVE EMBODIMENT(S)

Embodiments of the invention are described below with reference to the drawing figures wherein like numerals represent like elements throughout.

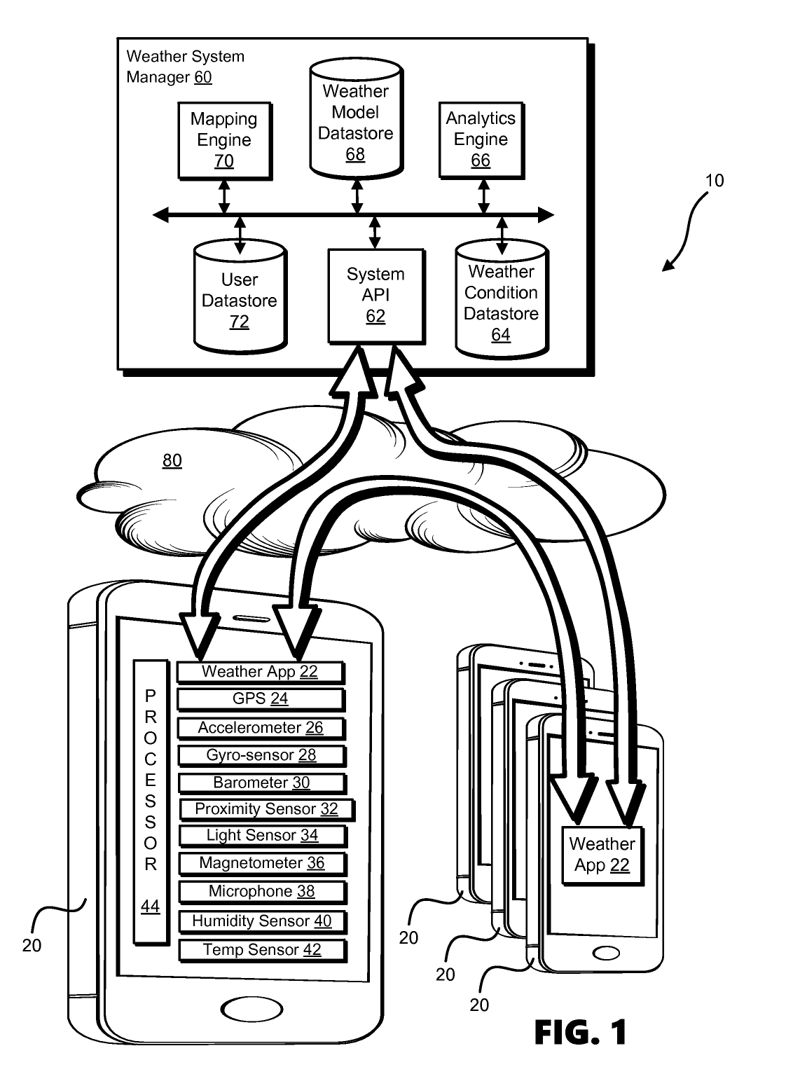

Referring to FIG. 1, a system 10 is provided including a weather system manager 60 (“system manager”) configured to aggregate and process data from mobile devices 20 for the purpose of determining current and future weather conditions and for the purpose of enabling other systems or devices to determine current and future weather conditions. The system manager 60 can function in a communications network 80, which can include one or more wired or wireless networks or a combination thereof (e.g., the Internet and mobile telecommunication networks), and collect sensor data and location data from the mobile devices 20.

The system manager 60 and its constituent elements are preferably implemented on one or more network-connectable processor-enabled computing systems via hardware components, software components (sharing one or more processing units), or a combination of hardware and software components. The system manager 60 could be executed for example on a stationary network-connectable server or a particular mobile device 20 operating on a mobile network. The system manager 60 need not be implemented on a single system at a single location, but can be decentralized for example in a peer-to-peer configuration, for example operating on two or more stationary network-connectable computer systems or two or more of the mobile devices 20. Systems described herein are configured to determine weather conditions based on the location and sensor outputs of a plurality of mobile devices 20.

The mobile device 20 can include for example a smartphone or other cellular enabled mobile device preferably configured to operate on a wireless telecommunication network. In addition to components enabling wireless communication, the mobile device 20 includes a location determination system, such as a global positioning system (GPS) hardware 24, an accelerometer 26, a gyro-sensor 28, a barometer 30, a proximity sensor 32, a light sensor 34, a magnetometer 36, and a microphone 38, humidity sensor 40, and temperature sensor 42 from which the mobile device 20 gathers sensor data using a weather application 22 (“weather app”) for predicting a current or future weather condition. A processor 42 enables the application 22, sensor hardware and related software. A user can carry the mobile device 20 on their person with the weather app 22 active to collect location data (e.g., from the GPS 24), weather data (e.g., temperature data, barometric pressure data, light level data, and humidity data), acceleration data, orientation data, magnetic field data, and other sensor data.

The system manager 60 includes a system application program interface (“API”) 62, a weather condition datastore 64, an analytics engine 66, a weather model datastore 68, a mapping engine 70, and a user datastore 72. The system manager 60 can be implemented on one or more network accessible computing systems in communication via a network 80 with mobile devices 20 which execute the weather app 22. Alternatively, the system manager 60 or one or more components thereof can be executed on one or more mobile devices 20, for example incorporated into the weather app 22, or executed on another system or a plurality of other systems.

Software and/or hardware (e.g., processor 42) residing on the mobile device 20 enables the weather app 22 to provide location and sensor data to the system manager 60 via the system API 24 . Alternatively, the weather app 22 executed on a particular mobile device 20 can enable transmission of location and sensor data through the network 80 to another mobile device 20 via its weather app 22.

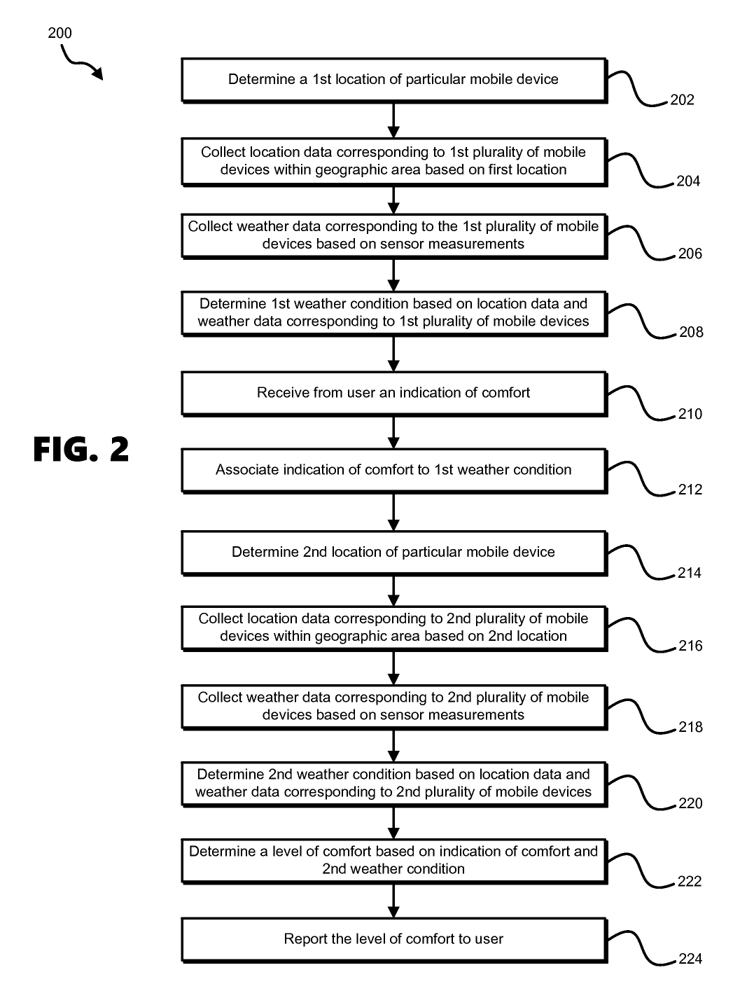

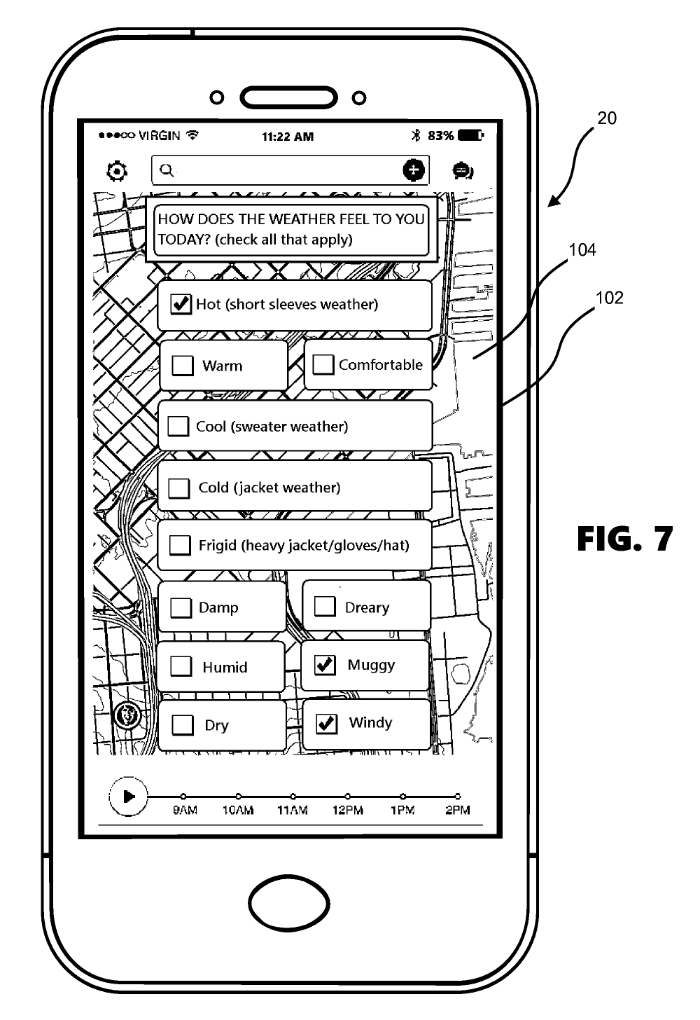

Referring to FIG. 2, a method 200 is shown for determining a weather condition in a particular geographic area and reporting the weather condition. The weather condition can include a present or future weather condition, for example a prediction of present or future precipitation, temperature, barometric pressure, and/or humidity. The method 200 and associated processes are described with reference to the components shown in the system 10 of FIG. 1, including the mobile device 20 and weather application 22, which are preferably configured for performing the method 200. The method 200 or particular steps thereof may alternatively be performed by other suitable systems, for example the system manager 20, in communication with one or more mobile devices 20 via a network 80. FIGS. 7-11 are provided to show exemplary user interface display outputs corresponding to particular steps the method 200 as described below.

The method 200 includes determining a first location of a particular mobile device 20 (step 202). The particular mobile device 20 can correspond to a user who requests a current or future weather condition via the weather app 22 executed on the particular mobile device 20. Location data is collected corresponding to a first plurality of mobile devices 20 within a particular geographic area defined based on the first location of the particular mobile device 20 (step 204). The first plurality of mobile devices 20 can correspond to devices also executing the weather app 22 but not necessarily in the process of responding to a user request for a weather condition via the weather app 22. The location data can be collected from the first plurality of mobile devices 20 based on GPS data generated by the first plurality of mobile devices 20 via GPS hardware 24 on the devices 20. Weather data is collected corresponding to the first plurality of mobile devices 20 based on sensor measurements from the first plurality of mobile devices 20 (step 206).

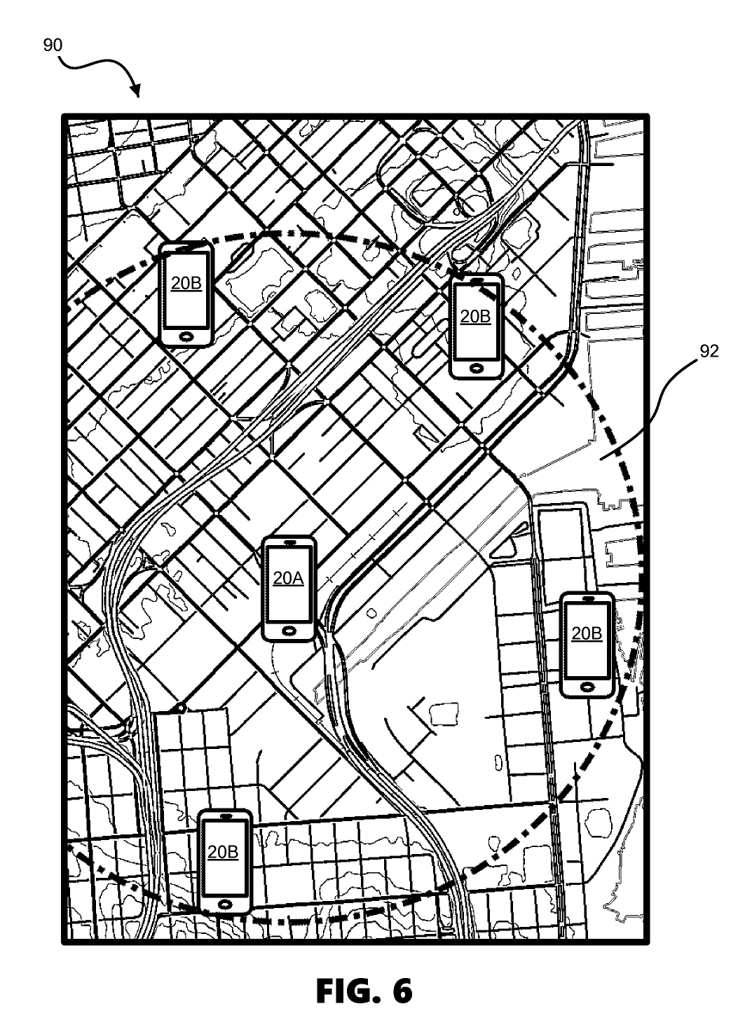

To identify the first plurality of mobile devices 20 from which relevant data is collected, the system manager 60 and/or the weather app 22 on the particular mobile device 20 can for example define the particular geographic area based on a location of the particular mobile device 20, receive location data from a plurality of mobile devices 20 in a particular region, and determine which of those mobile devices 20 are within the particular geographic area. Referring to FIG. 6 for example, a particular mobile device 20A is shown on a map 90 where a geographic area 92 is defined by a particular radius extending from the location of the mobile device 20A, wherein data is collected from a plurality of mobile devices 20B within the particular geographic area 92.

Referring further to the method 200, a first weather condition corresponding to a first time is determined based on the location data and the weather data from the first plurality of mobile devices 20 (step 208). Additionally, one or more sensor measurements can be performed by the particular mobile device 20, and the first weather condition can be further based on the one or more sensor measurements by the particular mobile device 20 and the first location of the particular mobile device 20. In other words, the first weather condition can be determined with or without weather data from the particular mobile device 20.

An indication of comfort corresponding to the first weather condition is received from a user of the particular mobile device 20 (step 210). Referring to FIG. 7, on a particular mobile device 20 the weather app 22 enables an exemplary display output 104 on a user interface (“UI”) 102 including a query “HOW DOES THE WEATHER FEEL TO YOU TODAY?” A list of selectable responses including “Hot (short sleeves weather)”, “Warm”, “Comfortable”, “Cool (sweater weather)”, “Cold (jacket weather)”, “Frigid (heavy jacket/gloves/hat)”, “Damp”, “Dreary”, “Humid”, “Muggy”, “Dry”, and “Windy” are further provided wherein the indication of comfort can be received in response to user selection of one or more of the responses.

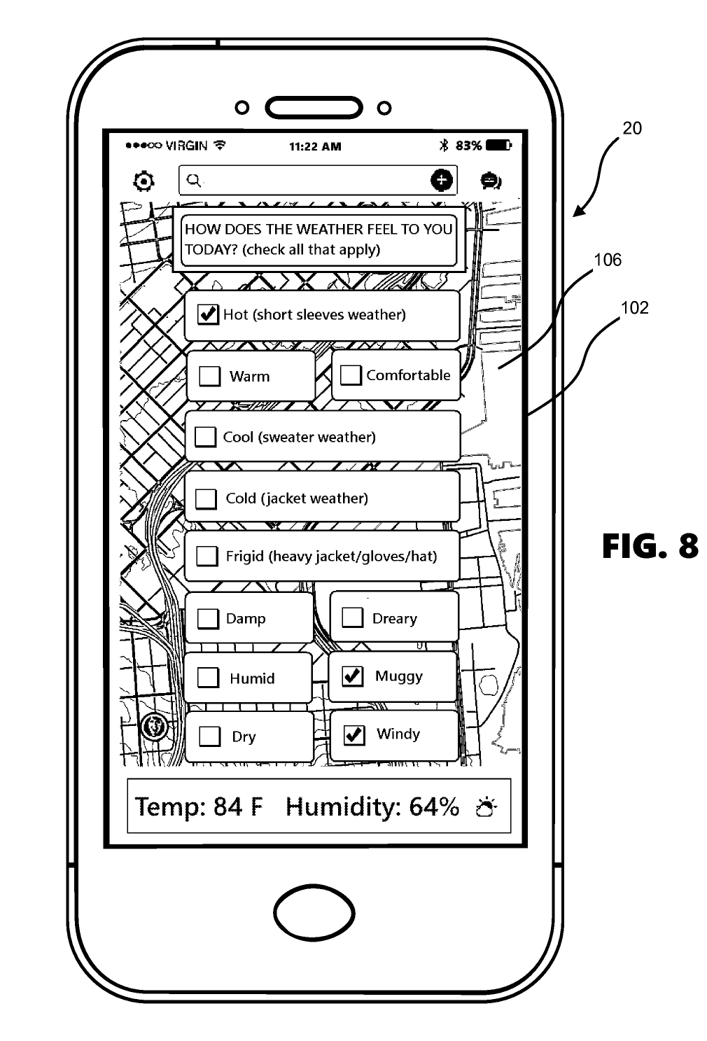

The first weather condition can be reported to the user and the indication of comfort can be provided by the user for example in response to the reported first weather condition. For example referring to FIG. 8, the weather app 22 can enable a display output 106 showing a current weather condition (e.g., temperature, humidity, and cloud cover), and input responses can be received via the UI 104 by user selection of the above-described responses. Alternatively, the indication of comfort can be provided by the user without first reporting the first weather condition as shown in FIG. 7. The indication of comfort received from the user is associated to the determined first weather condition corresponding to the first time (step 212). The indication of comfort can further be associated to the location of the particular mobile device 20 corresponding to the first time.

A second location of the particular mobile device 20 is determined based on later in time position data (step 214). Location data is collected corresponding to a second plurality of mobile devices 20 within a particular geographic area defined based on the second location of the particular mobile device 20 (step 216). Weather data is collected corresponding to the second plurality of mobile devices 20 based on sensor measurements from the second plurality of mobile devices 20 (step 218). The second plurality of mobile devices 20 can include one or more of the first plurality of mobile devices 20. A second weather condition corresponding to a second time is determined based on the location data and the weather data corresponding to the second plurality of mobile devices 20 (step 220). Additionally, one or more sensor measurements can be performed by the particular mobile device 20, and the second weather condition can be further based on the one or more sensor measurements by the particular mobile device 20 and/or the second location of the particular mobile device 20. In other words, the second weather condition can be determined with or without weather data from the particular mobile device 20.

A level of comfort is determined corresponding to the second weather condition corresponding to the second time based on the indication of comfort received from the user and based on the determined second weather condition (step 222). The level of comfort can be determined further based on the location of the particular mobile device 20 corresponding to the second time. For example if the temperature, barometric pressure, humidity, and location at the second time are substantially similar (e.g., within a particular measurement value) to the temperature, barometric pressure, humidity, and location at the first time, the level of comfort corresponding to the second time can be determined to be similar to the user-provided indication of comfort corresponding to the first time. Whereas if the temperature, barometric pressure, humidity, and location at the second time are similar to the temperature, barometric pressure, and humidity at the first time, but the location at the first time substantially differs (e.g., not within a particular distance value) from the location at the second time, the level of comfort corresponding to the second time can be determined to be dissimilar to the user-provided indication of comfort corresponding to the first (e.g., earlier) time.

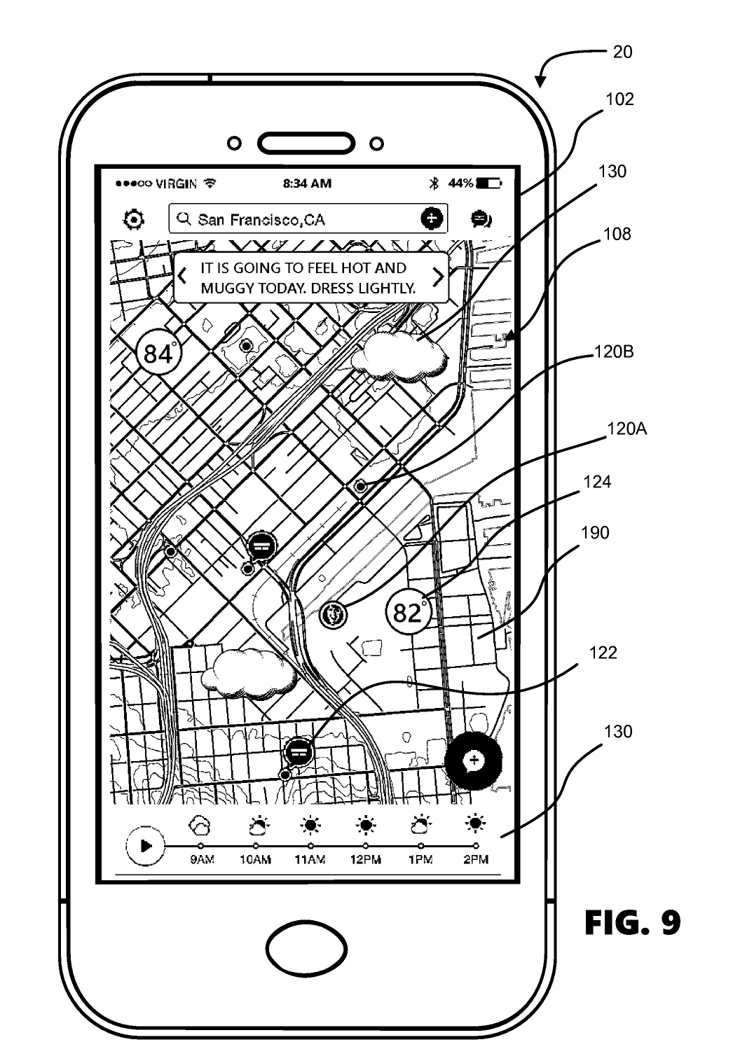

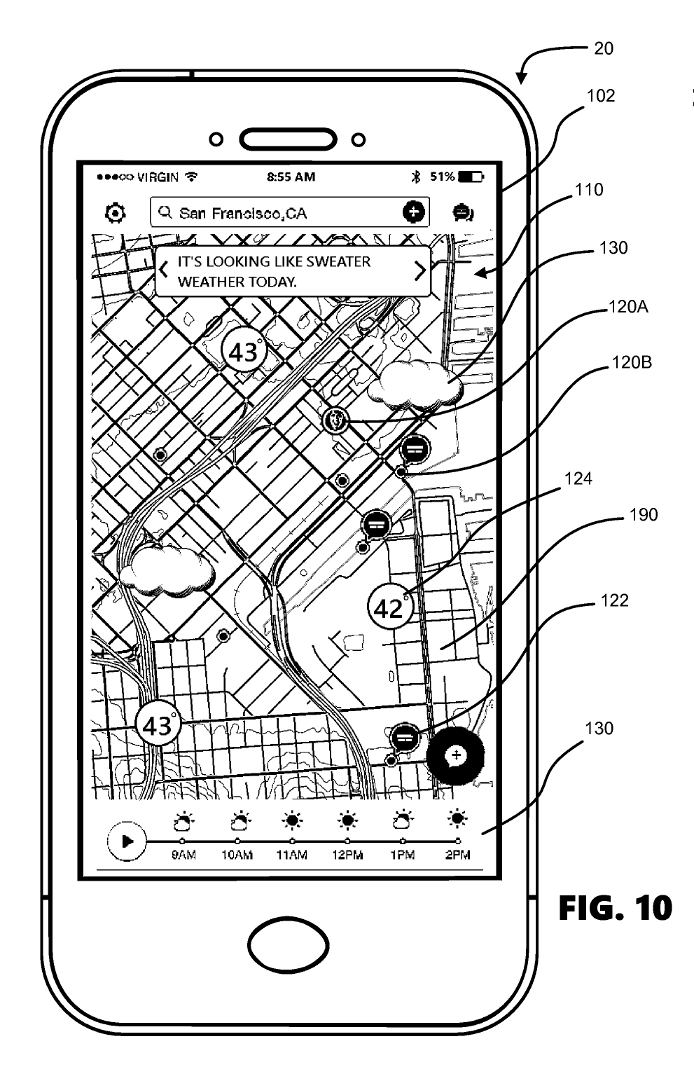

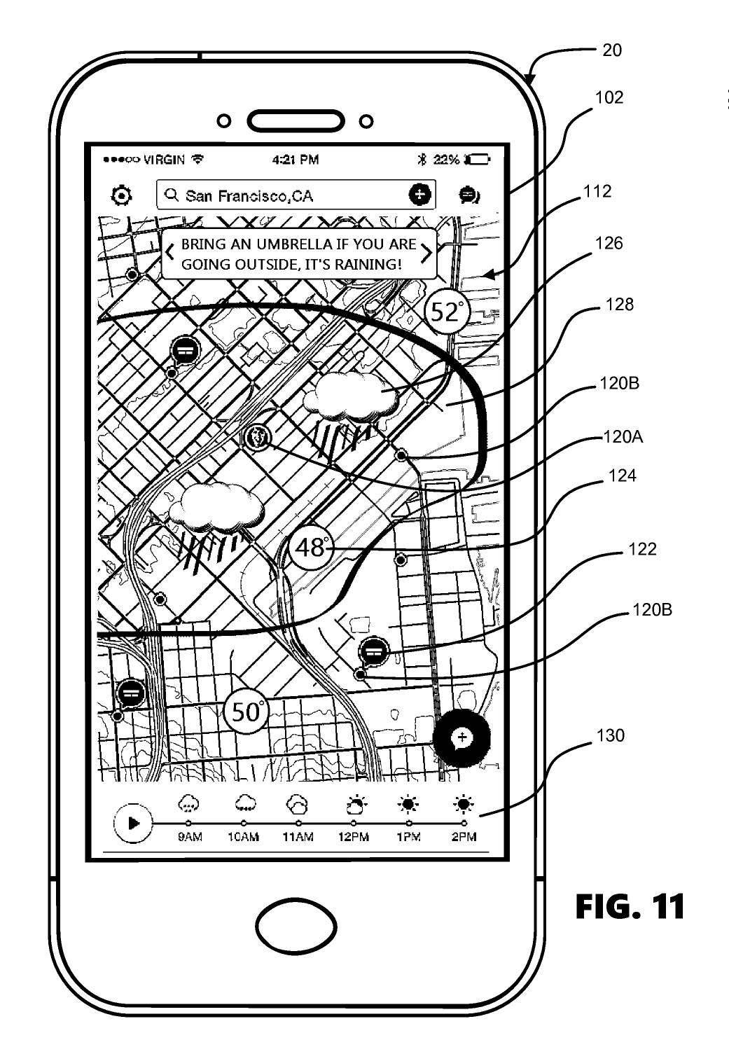

The determined level of comfort is reported to the user (step 224). Referring to FIGS. 9 through 11, the weather app 22 can enable display outputs showing weather conditions and reports of subjective levels of comfort. FIG. 9 shows an exemplary display output 108 including a map 190 which reports the level of comfort for a particular user by stating “IT IS GOING TO FEEL HOT AND MUGGY TODAY. DRESS LIGHTLY.” Output 108 can be based on the particular user's earlier indications that for similar weather conditions at similar locations she indicated that she felt hot and muggy. FIG. 10 shows an exemplary display output 110 which reports the level of comfort for a particular user by stating “IT'S LOOKING LIKE SWEATER WEATHER TODAY.” Output 110 can be based on the particular user's earlier indications that for similar weather conditions at similar locations she indicated that she needed a sweater. FIG. 11 shows an exemplary display output 112 which reports the level of comfort for a particular user by stating “BRING AN UMBRELLA IF YOU ARE GOING OUTSIDE, IT'S RAINING!” Output 112 can be based on the particular user's earlier indications that for similar weather conditions at similar locations she indicated that she needed an umbrella.

The collected weather data can include for example one or more of barometric pressure data, temperature data, and humidity data received from the mobile devices 20. The location data can include Global Positioning System (GPS) locates generated by the plurality of mobile devices 20 via corresponding GPS receivers 15 or location data from other source such as a telecommunication carrier device locating service. It follows that the determined weather conditions can comprise for example one or more of temperature, barometric pressure, and humidity information.

In practice, a user can provide many indications of comfort corresponding to many different weather conditions at different times and different locations. A level of comfort at a current time and location can be determined based on the plurality of previously provided comfort indications. Different times can correspond to day, evening, or night, winter, spring, summer, or fall. Different locations can correspond to different climates such as tropical, arid, semiarid, Mediterranean, humid subtropical, marine west coast, humid continental, subarctic, and highlands. By collecting the user-provided indications of comfort, the weather app 22 and/or the system manager 60 learn user comfort preferences and constructs one or more user-customized models for determining comfort levels of a particular user based on sensor and location inputs. Continued use of the weather app 22 allows for machine learning and refinement of the user-customized model(s).

A user might for example at a first time provide a particular indication of comfort for a particular temperature, humidity, and barometric pressure. At a later time that user might provide a different indication of comfort based on a substantially the same temperature, humidity, and barometric pressure. The user might feel differently at the later second time because of unmeasured conditions such as wind speed, cloud cover, geomagnetism, or chemical composition of the air (e.g., pollution). These unmeasured conditions may be closely tied to geographic location, and therefore associating an indication of comfort with a location is useful for training a model for determining a level of comfort of a user given sensor data (e.g., weather data) and known location.

A user may also feel differently at the later second time because it is a different time of day than the first time. For instance, a user may feel warmer in the evening than during the morning given similar weather conditions. Accordingly, an indication of comfort can further be associated with a time of day to train a model for determining a level of comfort of a user based on sensor data, time of day, and known location.

In an example process, weather data (e.g., temperature, barometric pressure) generated by sensors from a plurality of mobile devices 20 in proximity to a particular user may result in a determination of a particular level of comfort reported to a user as “IT'S COMFORTABLE-NO JACKET REQUIRED” on the UI the user's mobile device 20 when the user is located in Philadelphia, Pennsylvania. Substantially identical sensor data from another plurality of mobile devices 20 in proximity to the particular user may result in a determination of a particular level of comfort reported to a user as “A BIT CHILLY OUT-WEAR A SWEATER OR LIGHT JACKET” when the user is located on the Greek island of Lemnos. These determinations can be made based on the user's earlier comfort indications corresponding to when the user was located in Philadelphia and Lemnos. Alternatively, these determinations can be made based on the user's earlier comfort indications corresponding to when the user was located in places having climates similar to Philadelphia and Lemnos. For example, Philadelphia corresponds to a humid subtropical climate in an urban environment so a user's earlier comfort indications corresponding to New York City, which also has a humid subtropical climate in an urban environment, can be used as a basis for determining the user's level of comfort in Philadelphia for determined weather conditions.

The reliability of weather data received from the mobile devices 20 can be determined by the system manager 60 or the weather app 22 based on brightness data from the light sensors 34 and/or motion data (e.g., acceleration data) from accelerometers 26. A weather condition can be determined further based on the determine reliability of the weather data. For example, if a light sensor 34 of a particular mobile device 20 indicates a lack of light in the daytime it can be determined that the device may be in a user's pocket and therefore humidity data and temperature data can be ignored from that device. The system manager 60 or the weather app 22 can further ignore weather data from a mobile device 20 when that weather data from such device differs significantly from weather data retrieved from other nearby mobile devices 20.

In addition to weather data and GPS location data, mobile devices 20 can aggregate signal quality data to provide to the system manager 60 for use in determining whether a particular mobile device 20 is probably indoors. The signal quality data can include an indication of the type of signals received from a mobile device 20 (e.g., WiFi) and a level of distortion of received signals. An indoor device for example is more likely to encounter a relatively higher level of signal distortion than an outdoor device.

An indoor mobile device's weather data may be determined to be less reliable than weather data from an outdoor mobile device 20. When the system manager 60 or weather app 22 determines a particular mobile device 20 is probably indoors, some or all of the weather data from the device 20 (e.g., humidity and temperature data) can be ignored when making a determination of a weather condition. Note that barometric pressure is approximately the same indoors and outdoors at a given location. So the reliability of barometric pressure data from an indoor device is not significantly affected, and therefore barometric pressure data received from indoor mobile devices 20 is not necessarily ignored.

When a user of a particular mobile device 20 wants to determine a weather condition at a particular location, the system manager 60 via the mapping engine 70 is configured to determine which other mobile devices 20 are within a particular distance from the particular mobile device 20. The system manager 60 receives location data, weather data, and data for determining reliability of weather data from the other mobile devices 20 and delivers it to the particular mobile device 20 for determining the weather condition. For example data from mobile devices 20 within 5 km of the particular mobile device 20 can be used. Alternatively, the particular mobile device 20 can receive data directly from the other mobile devices 20 without the system manager 60 used as an intermediary.

The system manager 60 and the weather app 22 individually or in combination can apply one or more models to weather data for determining weather conditions in a geographic area, for example the Weather Research and Forecasting (“WRF”) Model and the Global Forecast System (“GFS”) Model. The Weather Research and Forecasting (WRF) Model is a mesoscale numerical weather prediction system available via wrf-model.org. The Global Forecast System (GFS) is a weather forecast model developed by the U.S. National Centers for Environmental Prediction (NCEP).

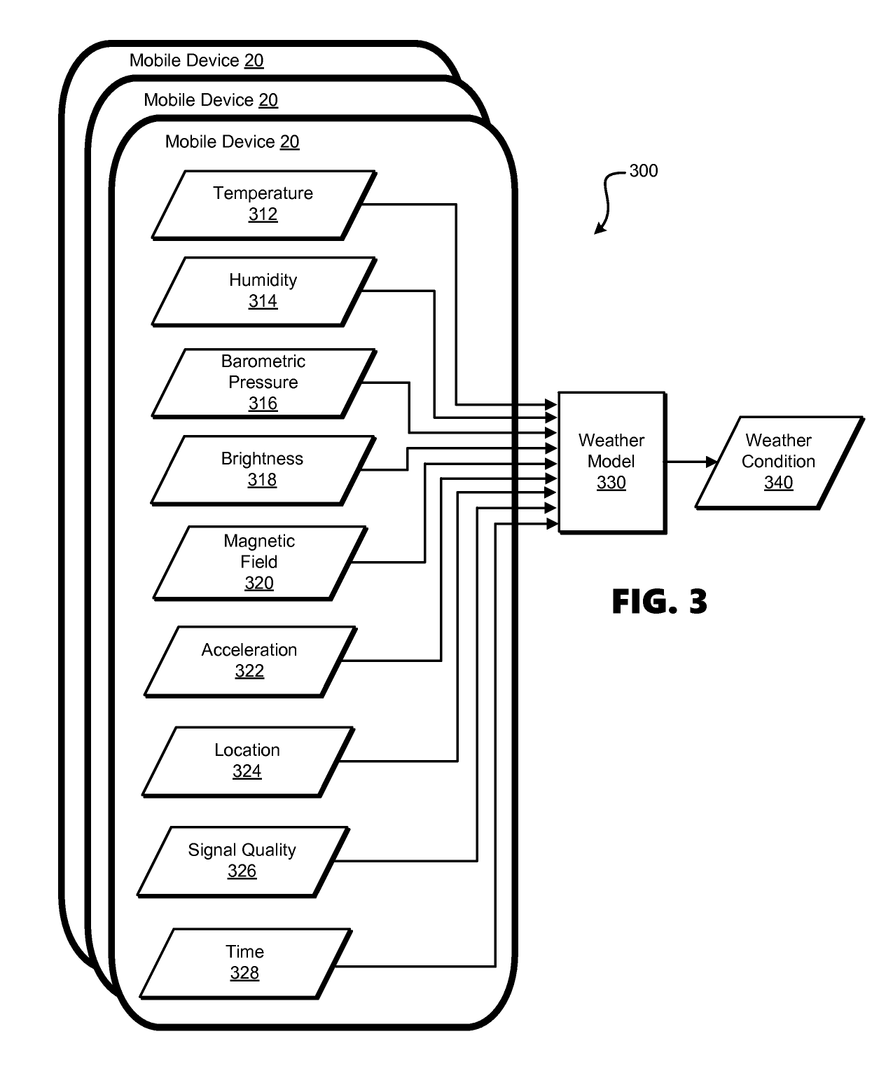

Referring to FIG. 3, a schematic 300 shows data flow in a process for determining weather conditions in a particular geographic area. Mobile devices 20 executing the weather app 22 to provide measurement-based data including one or more of temperature 312, humidity 314, barometric pressure 316, brightness 318, magnetic field 320, acceleration 322, location 324, signal quality 326, and time 328 associated with the data. Data from the mobile devices 20 is fed into a weather model 330 which can be stored in the datastore 68 which can be executed by the analytics engine 66 of the system manager 60 or executed via a processor 44 on a particular mobile device 20. The weather model 330 can incorporate one or both of the WRF and GFS models along with other rules, for example rules which account for the reliability of the data or ignore data which having values outside a particular range. A weather condition 340 is determined by implementing the weather model 330. Determined weather conditions 340 can be stored in the datastore 64.

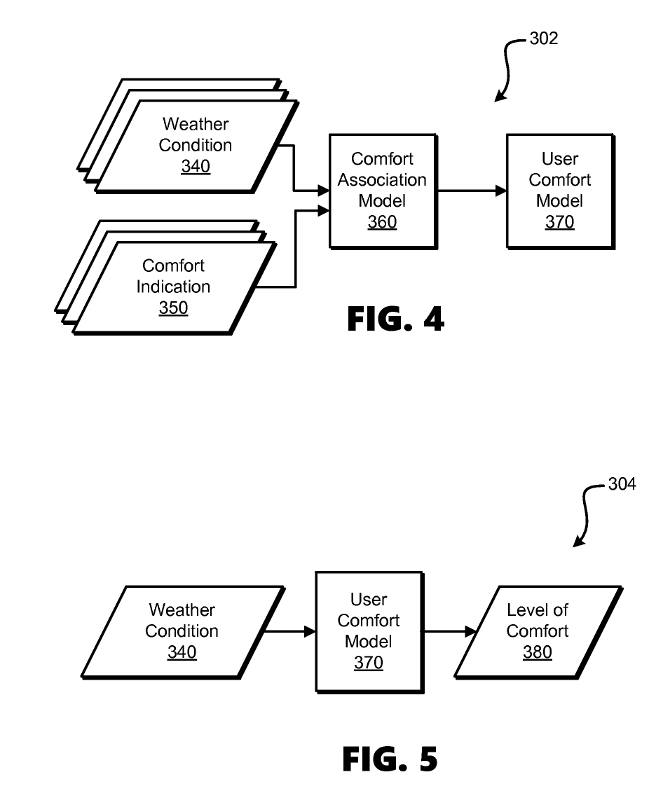

As indicated above with reference to FIGS. 6 and 7, the weather app 22 enables querying a particular user for a comfort indication, for example via exemplary display outputs 104, 106 on a user interface (“UI”) 102. The particular user can be queried for a comfort indication periodically (e.g. once a day, or once a week) at times when a present weather condition is known. Referring to FIG. 4, a schematic 302 shows a weather condition 340 is associated with a user provided comfort indication 350 using a comfort association model 360 to create a user comfort model 370 specific to the particular user. The comfort indication 350 should be collected as near in time as feasible to the collection time of the data used in determining the respective weather condition 340. The comfort model 370 is updated as new comfort indications 350 from the particular user are associated with their respective current weather conditions 340.

Referring to the schematic 304 of FIG. 5, the comfort model 370 is implemented at a later time to provide the particular user with a level of comfort 380 based on a present or future weather condition 340 determined based on later data from the same or different mobile devices 20. The particular user can submit a query for a level of comfort or weather condition via the weather app 22. The user can submit the query for example by actuating an icon on the UI of the user's mobile device 20 to activate the weather app 22 and cause the weather app 22 to open and operate in the foreground. Referring to display outputs 108, 110, and 112 of FIGS. 9-11, the level of comfort 380 for a current or future day can be reported to a user for example as “IT IS GOING TO FEEL HOT AND MUGGY TODAY. DRESS LIGHTLY”, “IT'S LOOKING LIKE SWEATER WEATHER TODAY”, or “BRING AN UMBRELLA IF YOU ARE GOING OUTSIDE, IT'S RAINING!” The level of comfort 380 can be reported periodically (e.g. once a day, or once a week) at times when a present or future weather condition is known. The level of comfort can be reported concurrently with a determined weather condition for example present or future precipitation, temperature, barometric pressure, and humidity as shown in FIGS. 8-10.

Display outputs 108, 110, and 112 of FIGS. 9-11 further show a primary user indicator 120A on a map 190 at a position corresponding to a determined location of a particular mobile device 20 implementing the weather app 22. Remote user indicators 120B correspond to determined locations of other mobile devices 20 implementing the weather app 22 in proximity to the particular mobile device 20 corresponding to the indicator 120A. The indicator 120A can include a photo of the particular user of the particular mobile device 20 as shown to help the user distinguish her position from the position of the other mobile device users. Clickable comment balloons 122 next to indicators 120B provide links to comments of users of corresponding mobile devices 20. Comments may be weather related (e.g. “What a beautiful day!”) or non-weather related (e.g., “Heading to the beach!” or “Having lunch at the park.”). Temperature indicators 124 provide estimated temperature at corresponding map locations. Referring to FIG. 11, rain clouds 126 show precipitation in an area 128 of the map 190. Referring to FIGS. 9 and 10, non-rain clouds 130 show cloud cover on the map 190. Precipitation and cloud cover at various times during the day is shown on a forecast bar 132.

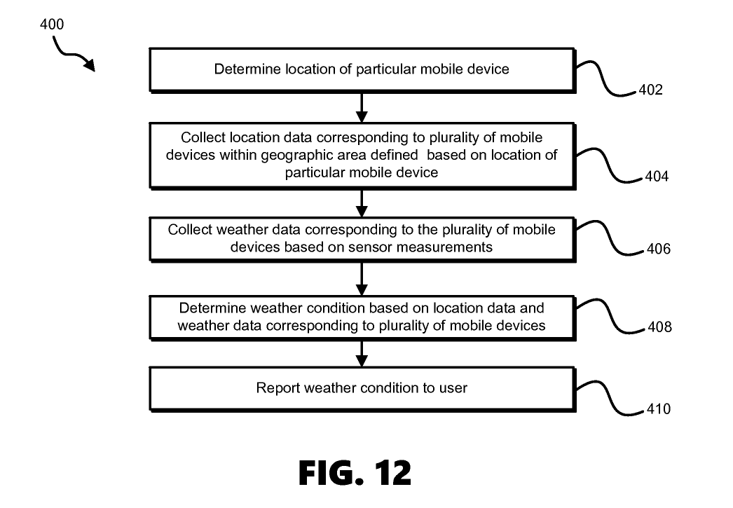

Referring to FIG. 12, a processor implemented method 400 is provided for determining a weather condition in a particular geographic area and reporting the weather condition. The method 400 is described with reference to the mobile devices 20 of FIG. 1, which are preferably configured for performing the method 400 via the weather app 22 as enabled by a processor 44. The method 200 or particular steps thereof may alternatively be performed by other suitable systems, for example the system manager 20, in communication with one or more mobile devices 20 via a network 80. The method 400 includes determining the location of the particular mobile device 20 (step 402) and collecting location data corresponding to a plurality of mobile devices 20 within the particular geographic area, the geographic area defined based on the location of the particular mobile device 20 (step 404). Weather data corresponding to the plurality of mobile devices 20 is collected based on sensor measurements from the plurality of mobile devices 20 (step 406). A weather condition is determined based on the location data and the weather data corresponding to the plurality of mobile devices 20 (step 408), and the weather condition is reported to a user of the particular mobile device 20 (step 410).

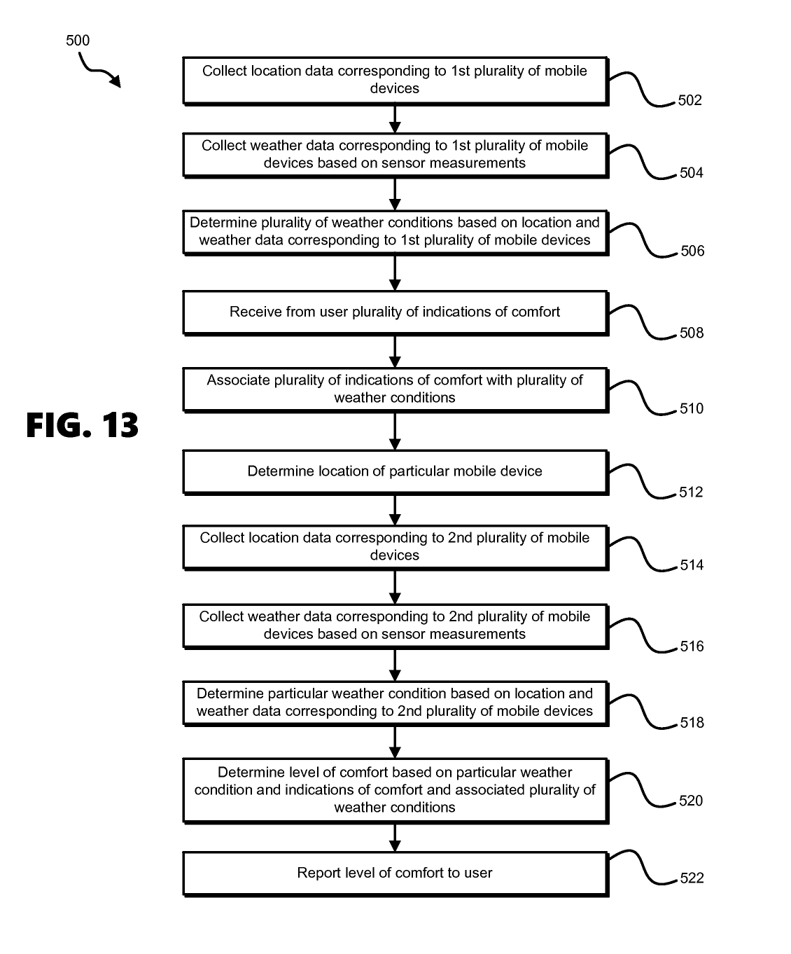

Referring to FIG. 13, a processor implemented method 500 is provided for determining a weather condition in a particular geographic area and reporting the weather condition. The method 500 is described with reference to the mobile devices 20 of FIG. 1, which are preferably configured for performing the method 500 via the weather app 22 as enabled by a processor 44. The method 200 or particular steps thereof may alternatively be performed by other suitable systems, for example the system manager 20, in communication with one or more mobile devices 20 via a network 80. The method 500 includes collecting location data corresponding to a first plurality of mobile devices 20 (step 502) and collecting weather data corresponding to the first plurality of mobile devices 20 based on sensor measurements from the first plurality of mobile devices 20 (step 504). A plurality of weather conditions are determined corresponding to particular times and particular locations based on the location data and the weather data corresponding to the first plurality of mobile devices 20 (step 506). A plurality of indications of comfort respectively corresponding to the determined plurality of weather conditions are received from a user of a particular mobile device (step 508). The plurality of indications of comfort are associated respectively to the plurality of weather conditions (step 510). A location of the particular mobile device is determined (step 512). Location data corresponding to a second plurality of mobile devices 20 is collected (step 514). Weather data is collected corresponding to the second plurality of mobile devices 20 based on sensor measurements from the second plurality of mobile devices 20 (step 516). A particular weather condition is determined based on the location data and the weather data corresponding to the second plurality of mobile devices 20 (step 518). A level of comfort is determined corresponding to the determined particular weather condition based on the particular weather condition and based on the indications of comfort received from the user and the respectively associated plurality of weather conditions (step 520), and the determined level of comfort is reported to the user (step 522). The step of determining the level of comfort and/or one or more of the above-described steps enabling the determination of the level of comfort can be performed in response to a query received from the user of the particular mobile device 20 via the weather app 22.

Although features and elements are described above in particular combinations, one of ordinary skill in the art will appreciate that each feature or element can be used alone or in any combination with the other features and elements. Methods described herein may be implemented in a computer program, software, or firmware incorporated in a computer-readable medium for execution by a computer or processor.

While embodiments have been described in detail above, these embodiments are non-limiting and should be considered as merely exemplary. Modifications and extensions may be developed, and all such modifications are deemed to be within the scope defined by the appended claims.

What is claimed is:

1. A processor implemented method performed by a particular mobile device for determining a weather condition in a particular geographic area and reporting the weather condition, the method comprising:
determining the location of the particular mobile device;
collecting location data corresponding to a plurality of mobile devices within the particular geographic area, the geographic area defined based on the location of the particular mobile device;
collecting weather data corresponding to the plurality of mobile devices based on sensor measurements from the plurality of mobile devices;
determining a weather condition based on the location data and the weather data corresponding to the plurality of mobile devices; and
reporting the weather condition to a user of the particular mobile device.

2. The method of claim 1, wherein the weather data comprises barometric pressure data.

3. The method of claim 1, wherein the weather data comprises at least one of temperature data, barometric pressure data, and humidity data.

4. The method of claim 1, wherein the location data comprises Global Positioning System (GPS) locates from the plurality of mobile devices.

5. The method of claim 1, further comprising:
determining a reliability of the weather data based on brightness data from light sensors of the plurality of other mobile devices; and
determining the weather condition further based on the determined reliability of the weather data.

6. The method of claim 1, further comprising:
determining a reliability of the weather data based on motion data from motion sensors of the plurality of mobile devices; and
determining the weather condition further based on the determined reliability of the weather data.

7. The method of claim 6, wherein the motion data comprises acceleration data from accelerometers of the plurality of mobile devices.

8. The method of claim 1, further comprising:
receiving signal quality data from the plurality of mobile devices;
determining a reliability of the weather data of the plurality of mobile devices;
determining the weather condition further based on the determined reliability of the weather data.

9. The method of claim 8, wherein determining the weather condition based on the weather data comprises selectively ignoring some of the weather data based on the determined reliability of the weather data.

10. The method of claim 1, further comprising:
determining that the plurality of mobile devices are within a particular distance of the particular mobile device; and
receiving the location data and weather data from the plurality of mobile devices responsive to determining that the plurality of other mobile devices are within the particular distance of the particular mobile device.

11. The method of claim 1, wherein determining the weather condition comprises applying at least one of the Weather Research and Forecasting (WRF) Model and the Global Forecast System (GFS) Model.

12. The method of claim 1, further comprising:
performing at least one sensor measurement by the particular mobile device; and
determining the weather condition further based on the at least one sensor measurement by the particular mobile device.

13. The method of claim 1, further comprising:
performing at least one sensor measurement by the particular mobile device; and
determining the weather condition further based on the at least one sensor measurement by the particular mobile device and the location of the particular mobile device.

14. The method of claim 1, further comprising:
receiving from the user of the particular mobile device an indication of comfort corresponding to the weather condition corresponding to a first time based on the location of the particular mobile device, the location data from the plurality of mobile devices, and the weather data from the plurality of mobile devices;
associating the indication of comfort to the weather condition corresponding to the first time; and
determining the weather condition based on the location of the particular mobile device, location data from a plurality of other mobile devices, and the weather data from a plurality of other mobile devices corresponding to a second time;
determining a level of comfort corresponding to the weather condition corresponding to the second time based on the indication of comfort received from the user and the determined weather condition at the second time; and
reporting the determined level of comfort to the user.

15. The method of claim 14, further comprising:
associating the indication of comfort to the location of the particular mobile device corresponding to the first time; and
determining the level of comfort corresponding to the weather condition corresponding to the second time further based on the location of the particular mobile device corresponding to the second time.

16. A processor implemented method for determining a weather condition in a particular geographic area and reporting the weather condition, the method comprising:
determining a first location of a particular mobile device;
collecting location data corresponding to a first plurality of mobile devices within a particular geographic area defined based on the first location of the particular mobile device;
collecting weather data corresponding to the first plurality of mobile devices based on sensor measurements from the first plurality of mobile devices;
determining a first weather condition based on the location data and the weather data corresponding to the first plurality of mobile devices;
receiving from a user of the particular mobile device an indication of comfort corresponding to the first weather condition;
associating the indication of comfort to the first weather condition;
determining a second location of the particular mobile device;
collecting location data corresponding to a second plurality of mobile devices within a particular geographic area defined based on the second location of the particular mobile device;
collecting weather data corresponding to the second plurality of mobile devices based on sensor measurements from the second plurality of mobile devices;
determining a second weather condition based on the location data and the weather data corresponding to the second plurality of mobile devices;
determining a level of comfort corresponding to the second weather condition based on the indication of comfort received from the user and the determined second weather condition; and
reporting the determined level of comfort to the user.

17. The method of claim 16, further comprising:
determining the second location of the particular mobile device is within a particular distance of the first location of the particular mobile device; and
determining the level of comfort based on the indication of comfort responsive to determining the second location is within the particular distance of the first location.

18. The method of claim 16, wherein the weather data comprises at least one of temperature data, barometric pressure data, and humidity data.

19. The method of claim 18, wherein the weather condition comprises at least one of a present precipitation, present temperature, present barometric pressure, and present humidity.

20. The method of claim 18, wherein the weather condition comprises at least one of a future precipitation, future temperature, future barometric pressure, and future humidity.

21. The method of claim 16, further comprising:
reporting the first weather condition to the user of the particular mobile device;
receiving from the user of the particular mobile device the indication of comfort corresponding to the first weather condition after reporting the weather condition to the user.

22. Non-transitory computer-readable media tangibly embodying a program of instructions executable by a processor to implement a method for determining weather conditions in a particular geographic area, the method comprising:
determining the location of a particular mobile device;
receiving location data corresponding to a plurality of mobile devices within the particular geographic area, the geographic area defined based on the location of the particular mobile device;
receiving weather data from the plurality of mobile devices based on sensor measurements from the plurality of mobile devices; and
determining a weather condition based on the location data from the plurality of mobile devices and the weather data from the plurality of mobile devices;
reporting the weather condition to a user of the particular mobile device.

23. A processor implemented method for determining a weather condition in a particular geographic area and reporting the weather condition, the method comprising:
collecting location data corresponding to a first plurality of mobile devices;
collecting weather data corresponding to the first plurality of mobile devices based on sensor measurements from the first plurality of mobile devices;
determining a plurality of weather conditions corresponding to particular times and particular locations based on the location data and the weather data corresponding to the first plurality of mobile devices;
receiving from a user of a particular mobile device a plurality of indications of comfort respectively corresponding to the determined plurality of weather conditions;
associating the plurality of indications of comfort respectively to the plurality of weather conditions;
determining a location of the particular mobile device;
collecting location data corresponding to a second plurality of mobile devices;
collecting weather data corresponding to the second plurality of mobile devices based on sensor measurements from the second plurality of mobile devices;
determining a particular weather condition based on the location data and the weather data corresponding to the second plurality of mobile devices;
determining a level of comfort corresponding to the particular weather condition based on the determined particular weather condition and based on the indications of comfort received from the user and the respectively associated plurality of weather conditions; and
reporting the determined level of comfort to the user.

24. The method of claim 23, further comprising:
determining that the first plurality of mobile devices are within a particular distance of the particular mobile device; and
determining the plurality of weather conditions responsive to determining that the first plurality of mobile devices are within the particular distance of the particular mobile device.

25. The method of claim 23, further comprising:
performing at least one sensor measurement by the particular mobile device; and
determining at least one of the plurality of weather conditions and the particular weather condition further based on the at least one sensor measurement by the particular mobile device.

26. The method of claim 25, further comprising determining the particular weather condition further based on the determined location of the particular mobile device.

27. The method of claim 23, wherein the plurality of weather conditions comprise at least one of present precipitation, present temperature, present barometric pressure, present humidity, future precipitation, future temperature, future barometric pressure, and future humidity.

28. The method of claim 23, further comprising:
reporting the plurality of weather conditions to the user of the particular mobile device; and
for each of the plurality of weather conditions, receiving from the user of the particular mobile device an indication of comfort after reporting the corresponding weather condition to the user.

29. The method of claim 23, further comprising:
receiving a query from the user of the particular mobile device; and
determining the level of comfort in response to the query from the user.
